(19) United States
(12) Patent Application Publication
(10) Pub. No.: US 2026/0233132 A1
(43) Pub. Date: Aug. 13, 2026

(54) SEPARATION SYSTEM, VACUUM ARRANGEMENT, AND USE OF A SEPARATION STAGE

(71) Applicant: Von Ardenne Asset GmbH & Co. KG, Dresden (DE)

(72) Inventors: Daniel Stange, Dresden (DE); Torsten Dsaak, Dresden (DE); Jan Kircheis, Bannewitz (DE); Marko Gruschka, Dresden (DE); Joerg Stiegler, Dresden (DE)

(21) Appl. No.: 19/531,572

(22) Filed: Feb. 5, 2026

(30) Foreign Application Priority Data
Feb. 10, 2025 (DE) 10 2025 104 722.7

(51) Int. Cl. B01D 29/56; B01D 29/90; B01D 36/00

(52) U.S. Cl. CPC B01D 29/56; B01D 29/90; B01D 36/001; B01D 36/008; B01D 2201/31; B01D 2221/14

(57) ABSTRACT

According to various embodiments, a separation system comprises: a material flow source; a first separation stage configured to separate a solid component; a second separation stage configured to feed a material flow supplied from the material flow source to the first separation stage and thereby separate a liquid component from the material flow; a recirculation device configured to supply the liquid component from the second separation stage to the material flow source.

### CROSS-REFERENCE TO RELATED APPLICATION

This Patent Application claims priority from German Patent Application No. 10 2025 104 722.7 filed on Feb. 10, 2025 according to 35 U.S.C. §119, the entire disclosure of which is incorporated herein by reference, in its entirety, and for all purposes.

Various embodiments relate to a separation system, a vacuum arrangement, and the use of a separation stage.

In general, a substrate may be treated (processed) in a vacuum, e.g., coated, so that the chemical and/or physical properties of the substrate may be changed. Various coating processes may be carried out to coat a substrate, of which physical vapor deposition (PVD) is an established representative. For example, a vacuum coating system may be used to deposit one or more layers on a substrate or on several substrates by chemical and/or physical vapor deposition. Pumps are used to generate the vacuum, and their exhaust air is conventionally filtered by a filter, e.g., a particle filter.

According to various embodiments, it has been illustratively recognized that low-cost filters are often susceptible to moisture or other liquids. For example, a liquid may clog the pores of the filter and/or accumulate in absorbent components of the filter. In this context, it has been recognized that the material flow fed to the filter may carry such liquid, which the material flow has absorbed, for example, from a liquid reservoir and which enters the filter and impairs it. An example of such a liquid reservoir is the liquid ring of a liquid ring pump, in which, for example, water is used as the liquid.

Various embodiments illustratively prevent the liquid from the material flow from entering the filter (e.g., particle filter) by separating the liquid beforehand and returning the separated liquid to its source, e.g., the liquid reservoir. This enables gentle operation of the filter (which extends its service life) without necessarily having to enrich the liquid, which in turn saves disposal costs. In other words, the liquid, which may itself be contaminated, is returned so that it remains in a cycle. In the case of the liquid ring pump, this enables cost-effective and low-maintenance operation of the liquid ring pump, as it does not dry out.

The above description may be applied analogously to any other source of liquid, e.g., any other liquid reservoir that does not necessarily contain water as the liquid. Other examples of liquid reservoirs include: coolant reservoirs, lubricant reservoirs.

Various examples are described below that relate to what is described herein and shown in the figures.

Example 1 is configured according to one of the attached claims and/or is a separation system comprising: a material flow source (e.g., comprising one or more fluid connections and/or a liquid reservoir); a first separation stage (also referred to as an additional separation stage or a solid separation stage), which is configured to separate (e.g., bind) a solid component (e.g., suspended solids); a separation stage (also referred to as a liquid separation stage or a second separation stage), which is configured to convey (e.g., transfer) a material flow between the material flow source and the first separation stage, thereby separating a liquid component from the material flow (e.g., by condensation); a recirculation device which is configured to feed the liquid component from the second separation stage back to the material flow source (also referred to as the source of a material flow).

Example 2 (e.g., a separation system and/or configured according to Example 1) refers to: a liquid reservoir; a first separation stage, which is configured to separate a solid component; a second separation stage (e.g., comprising a liquid separator) configured to supply a material stream (e.g., along a flow path) exposed to the liquid reservoir (also referred to as a liquid source or liquid dispenser) to the first separation stage, thereby separating a liquid component from the material stream; a recirculation device configured to feed the liquid component from the second separation stage to the liquid reservoir.

is a separation system comprising: a liquid reservoir; a first separation stage, which is configured to separate a solid component; a second separation stage (liquid separator), which is configured to feed a material flow (e.g. along a flow path) exposed to the liquid reservoir from the first separation stage and thereby separate a liquid component from the material flow; a recirculation device configured to feed the liquid component from the second separation stage to the liquid reservoir.

Example 3 (e.g., configured according to one of Examples 1 to 2) comprises: a flow path; a liquid reservoir to which a material stream (e.g., aerosol) fed to the flow path is exposed; a first separation stage (e.g., HEPA filter) which is arranged along the flow path behind the liquid reservoir and is configured to separate a solid component from the material stream; a second separation stage (e.g., liquid separator) arranged along the flow path behind the liquid reservoir and in front of the first separation stage and configured to separate a liquid component from the material stream ; a recirculation device configured to feed the liquid component from the second separation stage to the liquid reservoir.

Example 4 is an example of using a separation stage (e.g., liquid separation stage) to separate a liquid from a material stream from a material stream source, which is fed by the

separation stage from a material stream source to an additional separation stage (e.g., solid separation stage) for separating a solid component from the material flow, and for supplying the liquid to the material flow source.

Example 5 is the use of a separation stage to provide a liquid (e.g., by separating the liquid from the material stream) which is fed to a source of a material stream (also referred to as a material stream source), which is fed by the separation stage from the source of an additional separation stage for separating a solid component from the material stream.

Example 6 is the use of a liquid which is supplied by a separation stage (e.g., liquid separation stage) from a material flow which is supplied by the separation stage from a material flow source to an additional separation stage (e.g., solid separation stage) to separate a solid component from the material flow, is supplied to the material flow source (e.g., a liquid reservoir) to supply it with the liquid.

Example 7 (e.g., a separation system) is configured according to one of examples 1 to 6, wherein the material flow source has one or more than one fluid connection.

Example 8: A material flow separation system (e.g., a separation system) is configured according to one of examples 1 to 7, wherein the material flow source has a liquid reservoir or is coupled thereto (e.g., fluid-conducting), wherein the liquid reservoir preferably has the liquid component.

Example 9 (e.g., a separation system) is configured according to one of examples 1 to 8, wherein the material flow source comprises a pump or is mounted on a pump (e.g., comprising the liquid reservoir).

Example 10 (e.g., a separation system) is configured according to one of examples 1 to 9, wherein the first separation stage is of the absorption type and/or comprises a particulate air filter (e.g., HEPA) filter.

Example 11 e (e.g., a separation system) is configured according to one of examples 1 to 10, wherein the first separation stage has a plurality of (e.g., channel-shaped) pores by which the solid component is separated.

Example 12 (e.g., a separation system) is configured according to one of examples 1 to 11, wherein the first separation stage has a plurality of fibers by which the solid component is separated.

Example 13 (e.g., a separation system) is configured according to one of examples1 to 12, wherein the second separation stage is of the adsorption type and/or has a liquid separator (e.g., condensate separator).

Example 14: The separation system (e.g., a separation system) is configured according to one of examples 1 to 13, wherein the second separation stage has one or more wall elements (e.g., as separation elements) which are exposed to the material flow.

Example 15 (e.g., a separation system) is configured according to one of examples 1 to 14, wherein the second separation stage has a liquid drain (e.g., on the bottom side) into which the return device flows.

Example 16 (e.g., a separation system) is configured according to one of examples 1 to 15, wherein the second separation stage has one or more (e.g., cooled) adsorption surfaces which are exposed to the material flow.

Example 17 (e.g., a separation system) is configured according to one of examples 1 to 16, further comprising a first fluid line which opens into the second separation stage, e.g. a cavity (also referred to as an interior or separation stage interior) thereof, and/or is coupled to the material flow source, wherein the interior preferably tapers towards the first fluid line. For example, the second separation stage has a housing, wherein the housing (e.g., at least the interior provided therein, into which the first fluid line opens) preferably tapers toward the first fluid line. This geometry promotes relaxation of the material flow in the second separation stage, resulting in a pressure drop or at least promoting the separation of a liquid.

Example 18 (e.g., a separation system) is configured according to one of examples 1 to 17, wherein the interior space of the second separation stage opens into the first separation stage and/or wherein the housing of the second separation stage is mounted on the first separation stage.

Example 19 (e.g., a separation system) is configured according to one of examples 1 to 18, further comprising a cooling device which is configured to extract thermal energy from the second separation stage (e.g., its interior and/or its wall element) (also referred to as cooling). The cooling device promotes the separation of the liquid component, e.g., by condensation.

Example 20 (e.g., a separation system) is configured according to one of examples 1 to 19, further comprising a pump which comprises the liquid reservoir, wherein the pump is preferably configured to convey (e.g., transfer) the material flow by the liquid reservoir and to feed it to the second separation stage.

Example 21 (e.g., a separation system) is configured according to Example 20, wherein the pump is configured as a liquid ring pump.

Example 22 (e.g., a separation system) is configured according to one of examples 1 to 21, wherein the recirculation device has a second fluid line which opens into the pump and/or the material flow source.

Example 23 (e.g., a separation system) is configured according to one of examples 1 to 22, (e.g., the material flow source, e.g., the pump) and further comprising a third separation stage, which is configured to reduce the ratio of solid to liquid components in the liquid reservoir and/or to remove a solid component from the liquid reservoir. This inhibits an accumulation of the solid component in the liquid reservoir, which increases its operational compatibility.

Example 24 is a vacuum arrangement comprising: a vacuum chamber, which has a flange (also referred to as a pump connection flange) and a separation system according to one of claims 1 to 23 (e.g., 22 to 23), the first separation stage of which is coupled to the pump connection flange by the second separation stage (and/or the pump). Preferably, a transport device is arranged in the vacuum chamber, which is configured to transport a transport good (e.g., substrate) in the vacuum chamber.

Example 25 is a method comprising: separating a liquid component (also referred to as liquid separation) from a (e.g., liquid-containing) material stream after it has been exposed to a liquid reservoir and before a solid component is separated from it; and feeding the liquid component to the liquid reservoir; preferably separating a solid component (also referred to as solid separation) from the material stream resulting from the liquid separation.

Example 26 is a separation system comprising: a flow path; a liquid reservoir to which a material stream (e.g., aerosol) fed to the flow path is exposed; a first separation stage (e.g., HEPA filter) which is arranged along the flow path behind the liquid reservoir and is configured to separate a solid component from the material stream; a second separation stage (e.g., liquid separator) arranged along the flow path behind the liquid reservoir and in front of the first separation stage and configured to separate a liquid component from the material stream; a recirculation device configured to feed the liquid component from the second separation stage to the liquid reservoir.

Example 27 is configured according to one of claims 1 to 26, further providing a flow path for the material flow, along which the first separation stage is arranged between the liquid reservoir and the second separation stage.

Example 28 is configured according to one of claims 1 to 27, wherein the material flow has or consists of a fluid flow.

Example 29 is configured according to one of claims 1 to 28, wherein the material flow comprises or consists of a mixture.

Example 30 is configured according to one of claims 1 to 29, wherein the material flow comprises or consists of one or more gases.

Example 31 is configured according to one of claims 1 to 30, wherein the material flow comprises solid particles.

Example 32 is configured according to one of claims 1 to 31, wherein the material stream comprises or consists of a mixture of suspended solids.

Example 33 is configured according to one of claims 1 to 32, wherein the material flow source comprises (or is coupled to) a liquid reservoir to which the liquid component from the second separation stage is fed and/or to which the material flow is exposed.

Example 34 (e.g., a separation system) is configured according to one of examples 1 to 33, wherein the second separation stage comprises a cavity and at least one (i.e., one or more than one) wall element arranged in the cavity, which provides a condensation surface (e.g., for separating the liquid component) and/or is exposed to the material flow (e.g., its condensation surface) and/or.

Example 35 (e.g., a separation system) is configured according to one of examples 1 to 34, wherein the second separation stage is configured to separate the liquid component by condensation (then also referred to as a condensation separation stage).

Example 36 (e.g., a separation system) is configured according to one of examples 1 to 35, wherein the solid separation stage is downstream of the liquid separation stage.

Example 37 (e.g., a separation system) is configured according to one of examples 1 to 36, wherein the first separation stage (also referred to as an additional separation stage or as a solid separation stage) is configured to bind the solid component (e.g., suspended solids).

Example 38 (e.g., a separation system) is configured according to one of examples 1 to 37, wherein the second separation stage is configured to bind the liquid component.

Example 39 (e.g., a separation system) is configured according to one of examples 1 to 38, wherein the liquid component is a liquid contaminant and/or is carried along with the material flow as a gas phase (e.g., vapor).

Example 40 (e.g., a separation system) is configured according to one of examples 1 to 39, wherein the solid component is a solid impurity and/or is carried along with the material flow as a solid.

Example 41 (e.g., a separation system) is configured according to one of examples 1 to 40, wherein the separation of the liquid component from the material flow comprises converting a gaseous component of the material flow into the liquid component, e.g., by condensation of the gaseous component.

Example 42 (e.g., a separation system) is configured according to one of examples 1 to 41, wherein the recirculation device comprises or consists of a condensate drain.

Example 43 (e.g., a separation system) is configured according to one of examples 1 to 42, wherein the second separation stage has a recess (e.g., as a liquid drain) for collecting the liquid, into which the return device (e.g., a fluid line thereof) opens.

Example 44 (e.g., a separation system) is configured according to one of examples 1 to 43, wherein the pump is a fluid-transferring pump and/or a vacuum pump.

Example 45 (e.g., a separation system) is configured according to one of examples 1 to 44, wherein the material flow conveyed (e.g., transferred) by the second separation stage between the material flow source and the first separation stage is fed to the first separation stage and/or the second separation stage is fed from the material flow source (e.g., originating therefrom).

### FIGURES

FIGS. 1A to 2A each show a separation system according to different embodiments in a schematic side view or cross-sectional view;

FIGS. 2B to 3B each show a vacuum arrangement according to different embodiments in a schematic side view or cross-sectional view; and

FIG. 3C shows a method according to various embodiments in a schematic flowchart.

### DETAILED DESCRIPTION

The following detailed description refers to the accompanying drawings, which form part of this specification and in which specific embodiments are shown for illustrative purposes in which the invention may be practiced. In this regard, directional terminology such as "top," "bottom," "front," "back," "front," "rear," etc. is used with reference to the orientation of the figure(s) described. Since components of embodiments may be positioned in a number of different orientations, the directional terminology is for illustrative purposes only and is in no way limiting. It will be understood that other embodiments may be used and structural or logical changes may be made without departing from the scope of the present invention. It is understood that the features of the various exemplary embodiments described herein may be combined with each other, unless specifically stated otherwise. The following detailed description is therefore not to be construed in a restrictive sense, and the scope of protection of the present invention is defined by the appended claims. In this description, the terms "connected," "connected," and "coupled" are used to describe both a direct and an indirect connection (e.g., ohmic and/or electrically conductive, e.g., an electrically conductive connection), a direct or indirect connection, and a direct or indirect coupling. In the figures, identical or similar elements are given identical reference symbols, where appropriate. According to various embodiments, the term "coupled" or "coupling" may be understood in the sense of a (e.g., mechanical, hydrostatic, thermal, and/or electrical), e.g., direct or indirect, connection and/or interaction.

For example, several elements may be coupled together along an interaction chain along which the interaction may be exchanged, e.g., a fluid (then also referred to as fluid-conducting coupled). For example, two elements coupled together may exchange an interaction with each other, e.g., a mechanical, hydrostatic, thermal, and/or electrical interaction. A coupling of several vacuum components (e.g., valves, pumps, chambers, etc.) with each other may mean that they are fluidically coupled with each other. According to various embodiments, "coupled" may be understood in the sense of a mechanical (e.g., physical) coupling, e.g., by direct physical contact. A coupling may be configured to transmit a mechanical interaction (e.g., force, torque, etc.).

The term "processing device" herein refers to a device that is configured to process a substrate. Examples of the processing device and/or processing are configured to alter the substrate (e.g., geometrically, chemically, and/or physically) to, coat, clean, etch, etc. Examples of processing are additive (i.e., adding material) and/or subtractive (i.e., removing material). Examples of processing devices include: a heating device, a coating device, an etching device, etc.

Reference is made herein to a coating device as an exemplary processing device, whereby the description herein may apply analogously to a processing device of another type, e.g., a heating device, a coating device, an etching device, etc.

The term "coating device" herein refers to a device that is configured to perform a layer-forming process (also referred to as a coating process) and may, for example, include a so-called material source. According to various embodiments, the coating device may be configured to coat at least one substrate (i.e., one substrate or several substrates), which is transported through a coating area, for example. For example, the coating device may be configured to provide a gaseous coating material (material vapor) and/or liquid coating material, which may be deposited on the at least one substrate to form a layer. Examples of components of a coating device include: a sputter target as a material source, a plasma source, a crucible as a material source for thermal evaporation of the coating material (e.g., by a laser, electric arc, electron beam, and/or conductively supplied heat), a precursor source as a material source, and/or a liquid phase atomizer as a material source. A sputtering device may be configured to atomize the sputtering target by a plasma.

With regard to the layer-forming process, reference is made to vapor phase deposition as an exemplary coating process, e.g., physical vapor deposition (PVD) or chemical vapor deposition (CVD). In contrast to CVD, in PVD a solid coating material (which is provided as a target) is first converted into the gas phase (also referred to as the gaseous phase or vapor) and a layer is formed by this gas phase. In PVD, the gas phase of the coating material may optionally be chemically reacted with a reactive gas to form a chemical compound that is incorporated into or forms the layer. In the chemical reaction of PVD, two or more materials are thus combined to form the chemical compound. In chemical vapor deposition, a gaseous starting compound (also referred to as a precursor or reactant) is split into at least two reaction products, of which at least a first reaction product is incorporated into the layer as coating material and, optionally, a second reaction product is removed from the coating process as excess (e.g., by a pump). Optionally, CVD may be performed using a plasma in which the precursor is split.

The term "system" may be understood as a set of interacting entities. Examples of entities of the system include: at least one mechanical component, at least one electromechanical transducer (or other types of actuators), at least one electrical component, at least one instruction (e.g., encoded in a storage medium), and/or at least one control device.

According to various embodiments, the vacuum chamber may be or become provided by a chamber housing in which one or more chambers may be or become provided. The chamber housing may, for example, be configured to provide a negative pressure or (then also referred to as a vacuum chamber housing) a vacuum pressure (also referred to as a vacuum) for, and be coupled (e.g., gas-conducting) to a pump arrangement, e.g., a vacuum pump arrangement, and be configured to be stable in such a way that it may withstand the effects of air pressure in the pumped-out state. The pump arrangement (comprising at least one vacuum pump, e.g., a high vacuum pump, e.g., a turbomolecular pump) may enable part of the gas to be pumped out of the interior of the processing chamber, e.g., out of the processing space. Accordingly, one or more vacuum chambers may be provided in a chamber housing. In other words, the chamber housing may be configured as a vacuum chamber housing, or a coating chamber may be configured as a vacuum chamber.

A transport system may be understood as a set of interacting components, examples of which include: transport rollers, bearing device (by which, for example, each transport roller is rotatably mounted), coupling device, drive train, gearbox, drive device, etc. A transport system may be configured, for example, to transport a transport good (e.g., a substrate and, optimally, a substrate carrier) using the transport rollers. A transport device includes, for example, the transport system and, preferably, the substrate carrier.

The term "vacuum pressure" herein refers to a negative pressure in the vacuum range (i.e., a pressure of less than 0.3 bar), e.g., a pressure in a range from approximately 10 mbar to approximately 1 mbar (in other words, rough vacuum) or less, e.g., a pressure in a range from approximately 1 mbar to approximately 10-3mbar (in other words, fine vacuum) or less, e.g., a pressure in a range of approximately 10-3mbar to approximately 10-7mbar (in other words, high vacuum) or less, e.g., a pressure of less than high vacuum, e.g., less than approximately 10-7mbar.

According to various embodiments, a vacuum pump (comprising at least one high vacuum pump) may be configured to provide a vacuum pressure within a vacuum chamber. Vacuum pumps are generally used to generate a vacuum. The vacuum pumps are distinguished from one another according to the vacuum they generate and their operating principle. Depending on their physical operating principle, vacuum pumps are classified as gas-transferring vacuum pumps (i.e., vacuum pumps of the gas transfer type) and gas-binding vacuum pumps (i.e., vacuum pumps of the gas binding type).

A fluid-transferring vacuum pump (also known as a fluid transfer vacuum pump) transports a fluid either in a closed working chamber (also known as a displacement vacuum pump) or by transferring momentum to the fluid (e.g., through impacts). Typical examples of fluid transfer vacuum pumps are diaphragm pumps, reciprocating piston vacuum pumps, rotary vane pumps, sliding vane vacuum pumps, roller piston pumps, screw vacuum pumps, liquid ring pumps, molecular pumps, turbomolecular pumps, and liquid jet pumps.

Depending on the configuration, a vacuum pump may be configured to achieve a low vacuum pressure (e.g., a pressure of less than 10−3 mbar). The or each vacuum pump may optionally be part of a multi-stage configuration (e.g., provided as a pumping station). A first pumping stage (e.g., comprising a rotary vane pump) of the vacuum pump arrangement generates a preliminary vacuum and is often referred to as a fore-pump stage, wherein the subsequent pumping stage is connected to the recipient and provides, for example, a high vacuum.

A condensation separation stage is a separation stage that exploits the relationship between the vapor pressure and temperature of a material (e.g., the condensation of a gas when the temperature is reduced). The simplest configuration is the so-called cold trap, in which gases are condensed by cooling (e.g., with a cooling fluid). However, cooling may also be provided or achieved in other ways, e.g., by another refrigerant (e.g., in a compression refrigeration machine), such as ammonia, carbon dioxide, or another hydrocarbon, or by a Peltier element.

In the context of this description, the solid particles may be understood as particles (visually grains) that contain a solid or are formed from it, i.e., matter in a solid state of aggregation (whereby the matter may contain several atoms and/or molecules). The solid particles may have an average size (illustratively, particle size) of less than approximately 1 mm (e.g., less than 500 µm) and/or more than 5 nm (e.g., more than 0.1 µm), e.g., e.g., in a range from approximately 10 nm to approximately 500 µm, e.g., in a range from approximately 100 nm to approximately 100 µm, e.g., in a range from approximately 200 nm to approximately 10 µm, or in a range from approximately 0.1 µm to approximately 1 mm, e.g., in a range from approximately 1 µm to approximately 500 µm, e.g., in a range from approximately 10 µm to approximately 250 µm. The average size of a single solid particle may be roughly equivalent to the diameter of a sphere having the volume of the solid particle.

The term "matter" refers to anything that has mass and occupies space, e.g., a fluid and/or a mixture of materials. The term "flow" in the context of matter (e.g., a mixture), e.g., a material (e.g., matter flow), refers here to the transport (e.g., flow) of matter, e.g., along a flow path. The term "material flow" (also referred to as material stream) refers to a directed transport (also referred to as flow) of matter, e.g., a fluid. According to various embodiments, the material is a (e.g., fluid) mixture (then also referred to as a substance mixture) of several components, examples of which include: a colloid (e.g., an aerosol) and/or a solution. Examples of components of the material flow include: nitrogen, moisture (e.g., water droplets and/or water vapor) and/or solid particles (e.g., dust).

Here, reference is made, by way of example, to water as a liquid which (e.g., in its gaseous phase) is carried along in the material flow. The above description may be applied analogously to any other liquid, which does not necessarily have to be water. Other examples of liquids include: ammonia (e.g., as a coolant), oil, grease (e.g., as a lubricant), alcohol, or other polymers.

The term "separation" refers to a separation process by which two components (e.g., of a mixture, e.g., a gas mixture) are separated from each other, e.g., by sorption (e.g., adsorption and/or absorption) or another type of separation (e.g., binding). The term "separation" refers to mechanical separation.

For ease of understanding, the components of the mixture are distinguished from one another using more descriptive terms, such as impurity or carrier fluid. The carrier fluid, for example, is a harmless (e.g., non-toxic) component. The impurity refers to a component carried along with the carrier fluid (e.g., undesirable) that is to be separated from the carrier fluid. Examples of components of the mixture (e.g., material flow) include: a (e.g., gaseous) carrier fluid and one or more impurities (which are carried along with the carrier fluid, for example), e.g., solid particles and/or a liquid as impurities. The separation process changes the chemical composition of the mixture, for example by reducing the proportion of one or more impurities in the mixture.

The term "separation device" herein refers to a device that is configured to perform a separation process, e.g., by one or more separation elements of the separation device. The or each separation device may optionally be part of a multi-stage configuration (e.g., a separation system) (then also referred to as a separation stage). The separation device is configured to receive a mixture (e.g., fluid) and separate a component from it and to discharge the mixture depleted of the component, e.g., separately from the component.

According to various embodiments, a separation device (e.g., separation stage) has: one or more than one separation element (e.g., separator), at least one (i.e., one or more) inlet connection and at least one (i.e., one or more) outlet connection, which are coupled to each other (e.g., fluid-conducting) by the separator. A material, e.g., a material flow, is fed to the separation stage by the inlet connection. The separation stage discharges material by the outlet connection.

The term "separator" (also referred to as a separation device) refers to a separation element that is configured to separate a component of the mixture. A filter is defined here as a separator that is configured to separate a solid, e.g., solid particles (also referred to as a particle filter). A condensation separator is defined herein as a separator that is configured to separate a gas by condensation of the gas.

An exemplary implementation of a filter (e.g., particle filter) has pores and is configured to inhibit the passage of solid particles (also referred to as particle) through the pores, in particular particles that are larger than the pores of the filter. Alternatively or additionally, the particles cannot follow the flow of matter due to their inertia and collide with the filter, where they accumulate. Small particles may also be filtered out electrostatically, for which so-called electret filters are used. Examples of providing a filter having pores include: a composite of fibers (e.g., a woven fabric, a knitted fabric, a knitted fabric), a perforated membrane, felt, paper, nonwoven fabric, grain ceramics, channels, or the like.

From a technical point of view, particle filters are differentiated according to their separation efficiency (e.g., according to standard EN 1822-1:2009), for example, into high-efficiency particle filters (also known as EPA filters, EPA = "Efficient Particulate Air") and high-efficiency particulate air filters (also known as HEPA filters, HEPA = "High-Efficiency Particulate Air/Arrestance"). An exemplary implementation of a particle filter is configured to separate solid particles in the form of airborne particles (then also referred to as an airborne particle filter or HEPA filter). The HEPA filter can, for example, be provided by a depth filter and/or be configured to separate suspended particles with a diameter of less than 1 µm. This may apply, for example, to liquid suspended matter and/or solid suspended matter (e.g., solid particles), although the particle filter (e.g., its separation efficiency) may be impaired when absorbing liquid suspended matter.

The term " Fluid " refers herein to matter that continuously deforms under the influence of shear forces, for example, adapting to the shape of a container. For example, the fluid may offer no resistance to shear or only flow resistance (i.e., have a finite viscosity). For example, the fluid may be subject to the flow law above the yield point (DIN 1342). A fluid may contain or consist of a gas and/or a liquid, and may optionally contain solid particles. For example, a fluid may contain or consist of a suspension and/or an aerosol.

With regard to the pump, reference is made herein to a liquid ring pump as an exemplary pump, which is particularly low-maintenance and inexpensive. The term "liquid ring pump" refers to a pump (e.g., liquid vacuum pump) in which a so-called liquid ring is formed inside during operation. The liquid ring pump has a so-called impeller (e.g., a paddle wheel or screw wheel) which is arranged in a chamber (also referred to as a working chamber) of the pump and is mounted so that it may rotate, which is provided, for example, by the housing of the pump (also referred to as the pump housing). The interior of the working chamber (also referred to as the working space) may connect the inlet side of the pump (also referred to as the suction connection or inlet connection) to the outlet side of the pump (also referred to as the outlet connection) in a fluid-conducting manner. The impeller may have a bearing base and one or more blades (also referred to as vanes or teeth) rigidly attached thereto, each blade extending away from the bearing base and defining a cavity of the impeller (also referred to as the delivery chamber). The bearing section may, for example, comprise a shaft or at least a through-opening for receiving the shaft. The screw wheel (also referred to as a screw-type impeller) comprises one or more threads as a delivery chamber, each thread extending along a helical path around the axis of rotation. Two adjacent threads or two adjacent sections of the same thread are separated from each other by a blade, which also extends along a helical path around the axis of rotation. For example, the helical impeller, e.g., its blade, may have a helical shape.

If a pump is a liquid ring pump, the axis of rotation around which the impeller is rotatably mounted is arranged relative to the working chamber (also referred to as a liquid ring configuration) e.g., arranged in the working space, such that the axis of rotation is arranged eccentrically to the liquid ring formed during operation and/or eccentrically to a surface of the working chamber surrounding the axis of rotation, which delimits the working space. If the geometry of the working chamber (e.g., the working space and/or the outer surface) is at least partially rotationally symmetrical (e.g., in the case of a cylindrical working chamber), the axis of rotation of the impeller may be arranged eccentrically relative to the axis of rotational symmetry of the working space and/or the outer surface. If the geometry of the working chamber is non-rotationally symmetrical (e.g., in the case of an eight-shaped working chamber), the impeller may be arranged, for example, centrally and/or on an axis of symmetry of the working space and/or the outer surface. The impeller is arranged in the working chamber in such a way that the impeller (or at least its blades) is spatially separated from the outer surface in the radial direction (also referred to as contact-free). In other words, a gap may be formed between the impeller and the radial chamber walls of the working chamber, which runs along a closed path. During operation of the pump, the impeller is set in rotational motion, which transfers the rotational motion to the liquid (e.g., water) contained in the working chamber. As a result, the liquid forms a liquid ring (e.g., concentric with the working chamber) in the working chamber that fills the gap and seals the delivery chambers formed between the blades of the impeller against each other. The liquid ring is arranged eccentrically to the axis of rotation of the impeller, so that the blades are immersed to different depths in the liquid ring, which creates a piston effect by which suction and compression are alternately performed. The term "liquid ring screw pump" refers to a liquid ring pump whose impeller has one or more threads, i.e., is screw-like in configuration.

With regard to the liquid ring pump as an exemplary pump, however, it may be understood that, as an alternative to the liquid ring pump, a pump of another type (e.g., of the displacement type) may also be used, provided that the costs for this are acceptable.

A flange-shaped mounting device is also referred to herein as a flange and may be configured as a vacuum flange. The flange may be configured for rigid and/or detachable connection to another flange. Two interconnected flanges form a so-called flange connection. The flange may have a (e.g., planar) mounting surface. Optionally, the flange may be penetrated by an opening (also referred to as a flange opening) which is surrounded by the mounting surface, e.g., along a closed path. The flange connection may feature two flanges with their mounting surfaces facing each other, e.g., touching each other. The flange opening of a vacuum chamber housing may open into the interior of the vacuum chamber housing, e.g., adjacent to it. Optionally, the flange may have a groove that surrounds the flange opening, e.g., along the closed path surrounding the flange opening, and/or adjacent to the mounting surface. A seal, e.g., a metal seal or a plastic seal, may optionally be accommodated in the groove. Optionally, the flange may have a projection that has the mounting surface. For example, the mounting surface may protrude.

A liquid reservoir may have a cavity (also referred to as a liquid collection space) and/or a liquid (e.g., a quantity of liquid) which is, for example, contained in the cavity or present in an r other form (e.g., bound). The liquid reservoir illustratively provides a volume (e.g., of the liquid or at least of the cavity). The liquid reservoir may, for example, contain the liquid or consist of it. The liquid reservoir may, for example, be provided by a hollow body (e.g., container) which has the liquid receiving space.

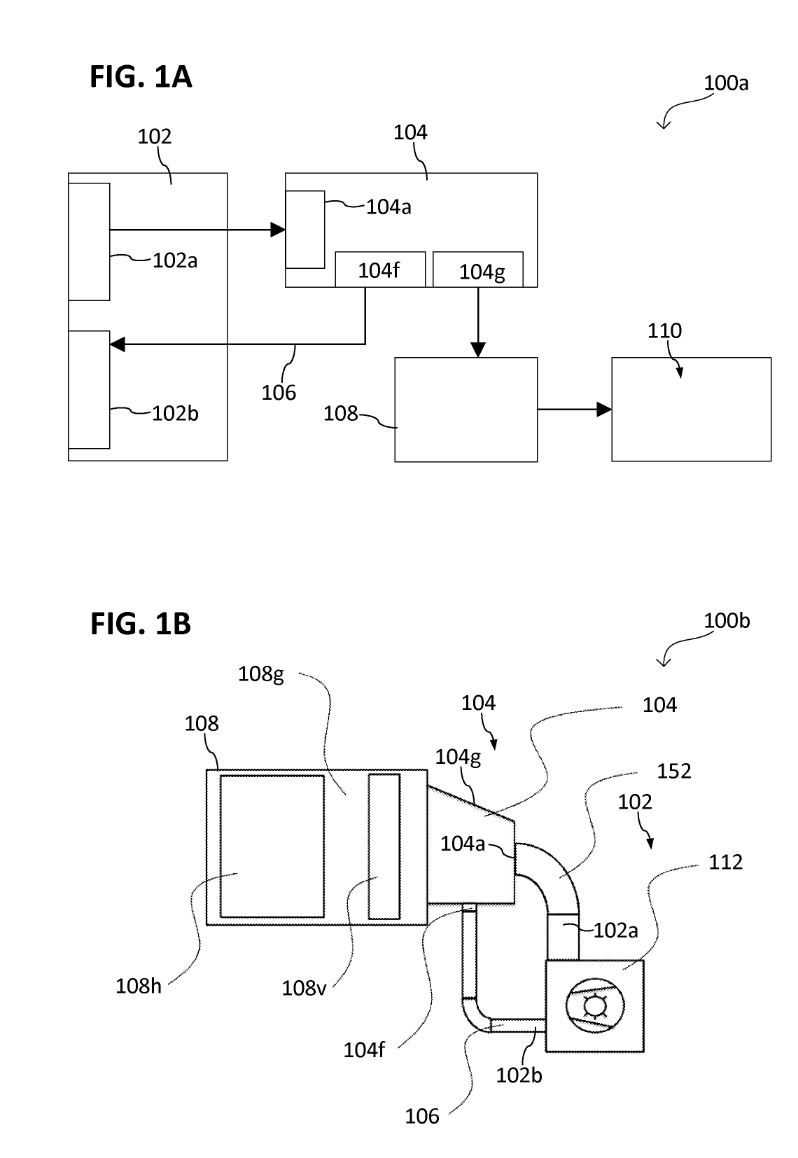

FIG. 1A illustrates a separation system according to various embodiments 100a in a schematic side view or cross-sectional view, preferably configured according to Example 1.

An exemplary implementation of the material flow source 102 has two fluid connections 102a, 102b, comprising at least a first fluid connection 102a (also referred to as a receiving connection) and a second fluid connection 102b (also referred to as a return connection). The intake port 102a is coupled (e.g., by a fluid line) to an inlet port 104a of the liquid separation stage 104. The return port 102b is provided by the return device 106 or is at least coupled by the return device 106 to a first outlet port 104f (also referred to as liquid port 104f) of the liquid separation stage 104.

An exemplary implementation of the liquid separation stage 104 is configured as a 3-way liquid separation stage, i.e., having three ports, and has a liquid separator. The inlet port 104a is configured to receive a stream of material (e.g., containing liquid) (also referred to as an outlet mixture). The separator is configured to separate a liquid component (e.g., water) from the outlet mixture and feed it to the liquid port 104f. The separator is also configured to feed the material flow resulting from the separation (also referred to as an intermediate material flow, e.g., a mixture), which has less liquid component than the initial mixture, to a second outlet connection 104g (also referred to as a gas connection 104g).

An exemplary implementation of the liquid separator has a cold trap as a separating element, which is configured to separate the liquid from the initial mixture by condensation.

An exemplary implementation of the solid separation stage 108 features a porous material as a filter, e.g., cellulose. The porous material is configured to separate solid particles as solids, which are accumulated in the pores of the filter, for example. Alternatively or additionally, an electrostatic filter and/or a centrifugal separator may also be used as a filter. The material flow (also referred to as filtrate) resulting from separation by the solid separation stage 108 is discharged, for example, into the Earth's atmosphere 110.

FIG. 1B illustrates a separation system according to various embodiments 100b in a schematic side view or cross-sectional view, preferably configured according to example 9 and/or embodiments 100a.

An exemplary implementation of the pump 112 is configured as a liquid ring pump and has an exhaust gas connection as a receiving connection 102a. The pump 112 is coupled to the liquid separation stage 104 by a fluid line 152 (also referred to as an exhaust line or exhaust pipe). For this purpose, the fluid line 152 opens into, for example, the intake port 102a and the inlet port 104a of the liquid separation stage 104.

The liquid ring pump has a reservoir of liquid (also referred to as a liquid reservoir) from which a liquid ring is formed during operation of the liquid ring pump. An exemplary implementation of the liquid reservoir uses water as the liquid. During operation, the liquid may be exposed to the material flow and thereby absorb components of the material flow that contaminate the liquid. This may make it difficult to handle the liquid, which may result in additional costs.

An exemplary implementation of the fluid separation stage 104 has a housing 104g, on the underside of which a drain connection 104f is arranged as a fluid connection, into which a fluid line of the return device 106 opens. The fluid line of the return device 106 also opens into the return connection 102b of the material flow source 102.

By the return device 106, which opens into the return connection 102b, liquid separated by the liquid separation stage 104 is fed to the liquid reservoir. This inhibits the decrease in the amount of liquid in the liquid reservoir, which extends the service life of the liquid ring pump, for example, the period of time until the liquid of the liquid ring pump is consumed.

An exemplary implementation of the housing (see Example 17) of the liquid separation stage 104 provides a cavity (also referred to as an interior space) that tapers toward the inlet port 104a of the liquid separation stage 104 and opens into the solid separation stage 108 (e.g., its interior). The tapered geometry of the interior acts as a pressure-varying separation element. This promotes the formation of a pressure drop in the second separation stage, which promotes the separation of a liquid.

An exemplary implementation of the solid separation stage 108 comprises housing 108g (also referred to as a solid filter housing) and two filters 108h, 108v, which are arranged in the housing 108g. The two filters 108h, 108v are, for example, disposed one behind the other along the flow path and/or differ from each other, for example, in their separation efficiency (e.g., by at least 1%), their porosity, and/or pore size.

An exemplary implementation of the two filters 108h, 108v has a first filter 108h, which is configured as a HEPA filter, and a second filter 108v (also referred to as a prefilter), which is configured as an EPA filter. The pre-filter is arranged between the HEPA filter and the liquid separation stage 104 so that the intermediate material flow discharged from the liquid separation stage 104 flows through the pre-filter and subsequently through the HEPA filter.

An exemplary implementation of the HEPA filter includes a stack of filter mats mounted in a frame for easy replacement. Each of the filter mats is provided, for example, by a glass fiber mat and/or has fibers with a fiber diameter of approximately 1 to 10 µm.

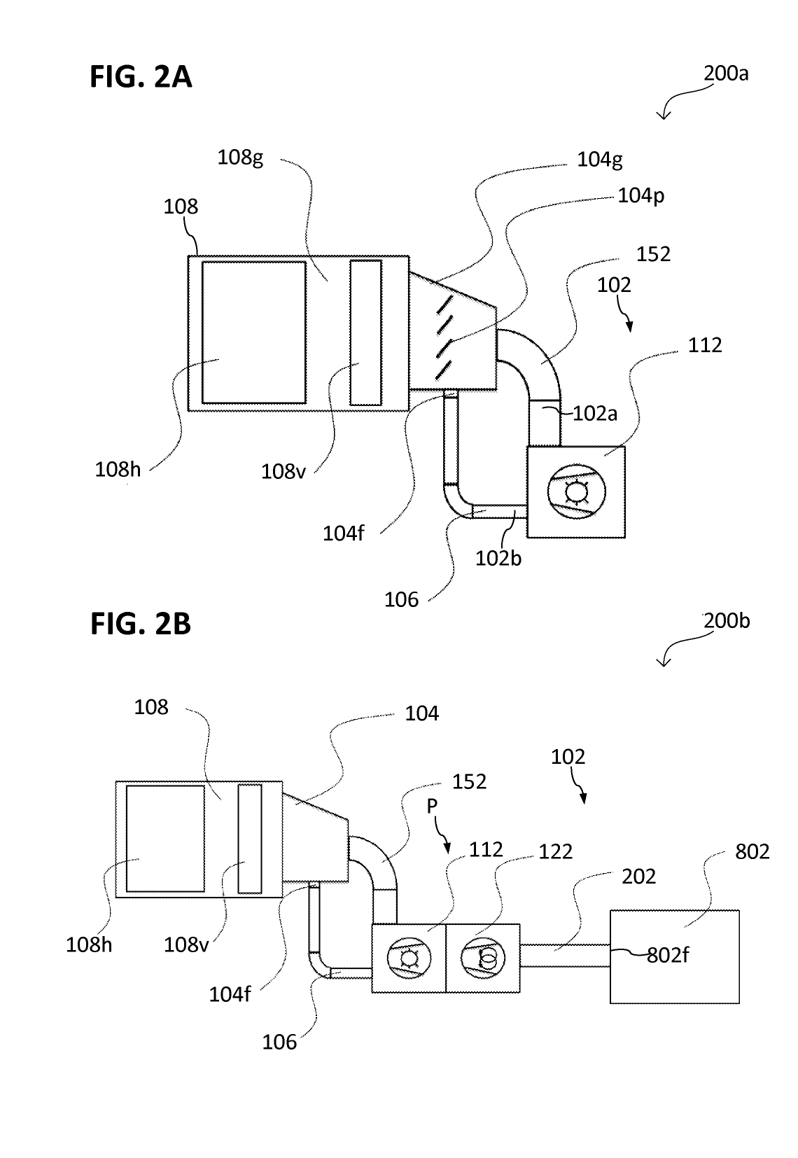

FIG. 2A illustrates a separation system according to various embodiments 200a in a schematic side view or cross-sectional view, preferably configured according to Example 1 and/or according to one of embodiments 100a to 100b.

An exemplary implementation of the liquid separation stage 104 has several baffles 104p as wall elements, which are arranged in the interior of the liquid separation stage 104. The baffles 104p increase the surface area on which liquid may separate. Each of the baffles 104p may be oriented at an angle to the flow path, which improves their effectiveness. The baffles 104p illustratively influence the flow in the liquid separation stage 104.

FIG. 2B illustrates a vacuum arrangement with a separation system according to various embodiments 200b in a schematic side view or cross-sectional view, preferably configured according to example 24 and/or according to one of the embodiments 100a to 200a. The pump connection flange 802f of the vacuum chamber 802 is coupled by a fluid line (then also referred to as a pump line) to a pump station P, which couples the vacuum chamber 802 to the liquid separation stage 104.

An exemplary implementation of the pump station P has several vacuum pumps, e.g., a screw pump as a backing pump 122 and a liquid ring pump as a main pump (e.g., high vacuum pump).

An exemplary implementation of the vacuum chamber 802 is provided by a chamber housing in which a coating device and/or a transport device are arranged. The transport device is configured to transport a substrate in the vacuum chamber 802, e.g., along a transport path. The coating device is configured to coat the substrate in the vacuum chamber 802, which is transported, for example, along the transport path.

An exemplary implementation of the coating device is configured to coat the substrate using a gaseous coating material (also known as gas phase deposition), e.g., using PVD and/or CVD. The gaseous coating material mixes with the process atmosphere provided in the vacuum chamber 802, which is extracted as a material flow by the pump station P of the vacuum chamber.

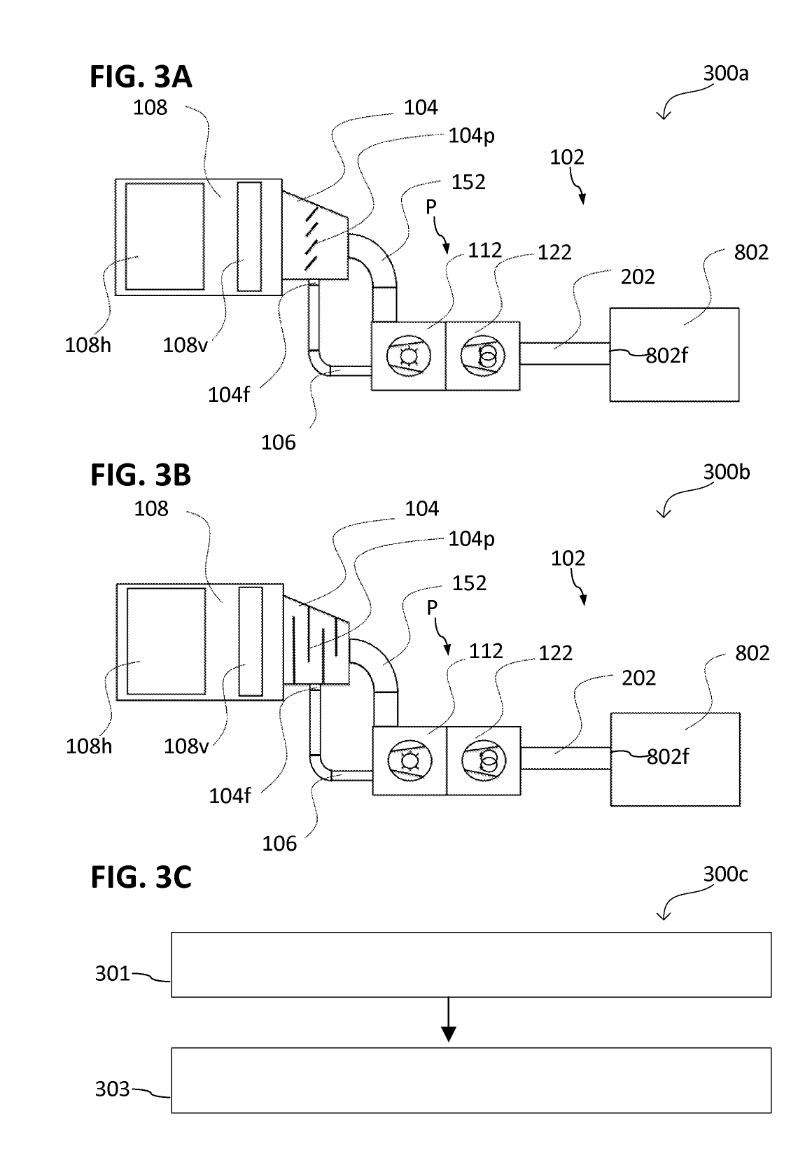

FIG. 3A illustrates a vacuum arrangement with a separation system according to various embodiments 300b in a schematic side view or cross-sectional view, preferably configured according to example 9 and/or according to one of the embodiments 100a to 200b.

FIG. 3B illustrates a vacuum arrangement with a separation system according to various embodiments 300b in a schematic side view or cross-sectional view, preferably configured according to example 9 and/or according to one of the embodiments 100a to 300a. As shown, the baffles 104p provide a meandering channel into which the liquid connection 104f and/or the fluid line 152 open.

FIG. 3C illustrates a method according to various embodiments 300c in a schematic flow diagram, preferably configured according to example 25 and/or for operating a separation system according to one of the embodiments 100a to 300a.

An exemplary implementation of the material flow originates from a vacuum chamber and is exposed to a liquid reservoir of a pump station P, from which the material flow takes up liquid from the liquid reservoir (also referred to as a liquid-bearing material flow).

The liquid-containing material flow is fed to the liquid separator 301, which separates the liquid from the liquid reservoir as a liquid component from the material flow. The result of the liquid separation 301 comprises the intermediate material flow and the separated liquid. The separated liquid is fed to the liquid reservoir 303.

The intermediate material stream is fed to the solid separation unit, which separates solid suspended matter from the intermediate material stream as a solid component. Solid separation is carried out by a porous filter, e.g., comprising several fiber-containing filter mats. The more liquid the intermediate material stream carries, the more the porous filter is impaired. Liquid separation 301 inhibits this impairment.

Various working examples are described below that relate to what is described herein and shown in the figures.

According to an example of operation 1, a filter housing is provided in which a water separator of the liquid separation stage is arranged and into which the exhaust line of a pump station (e.g., comprising one or more vacuum pumps) opens. The pump station is used to extract a stream of material from a vacuum chamber of a vacuum system. The coating system also has a coating device in the vacuum chamber (then also referred to as a coating system).

According to a working example 2, which may be optionally configured according to working example 1, the pump station (e.g., vacuum pump station) has one or more liquid ring pumps, by which the material flow is conveyed (e.g., transferred). The liquid ring pump discharges water into the material flow, thereby increasing its humidity. The material flow discharged by the liquid ring pump into the exhaust gas line has, for example, a high air humidity. The air humidity of the material flow is removed by the liquid separation stage into which the exhaust gas line flows. This prevents the prefilter and/or HEPA filter of the solid separation stage 108 from absorbing moisture.

According to a working example 3, which may be optionally configured according to one of working examples 1 to 2, the moisture separated by the liquid separation stage is collected by the recirculation device and fed to the liquid ring pump.

According to a working example 4, which may be optionally configured according to one of working examples 1 to 3, the liquid separation stage is provided by a funnel as a housing (also referred to as a housing funnel), which is mounted on the solid filter housing and optionally has a flat underside at which a drain support opens into the funnel. The bottom surface, at which a drain support opens into the funnel, may, for example, have a liquid-collecting shape (e.g., an inclined surface, a drain support at the lowest point).

According to a working example 5, which may be optionally configured according to one of the working examples 1 to 4, the liquid separation stage has several baffle plates arranged in the housing funnel on which the moisture condenses. Optionally, the baffle plates may be cooled to promote condensation.

According to a working example 6, which may be optionally configured according to one of the working examples 1 to 5, inexpensive filters may be used to provide the solids separation stage, as these are protected from moisture by the liquid separation stage. This reduces the acquisition and maintenance costs of the solids separation stage. An example of low-cost filters is glass fibers and/or cellulose.

According to a working example 7, which may be optionally configured according to one of working examples 1 to 6, the material flow supplied to the pump (e.g., liquid ring pump) contains suspended solids, e.g., liquid and/or solid suspended solids. Alternatively or additionally, the material flow supplied to the pump (e.g., liquid ring pump) has a relative humidity (e.g., water vapor) of less than 100% (e.g., less than 10%, e.g., less than 1%). The term "water vapor" herein refers to water in the gaseous state.

According to a working example 8, which may be optionally configured according to one of the working examples 1 to 7, the relative humidity of the material flow is increased by the pump (e.g., liquid ring pump), e.g., by at least 10% (e.g., at least 50%, e.g., at least 90%).

According to a working example 9, which may be optionally configured according to one of working examples 1 to 8, the (e.g., liquid-containing) material stream that is fed to the liquid separation stage has a relative humidity of approximately 100%.

According to a working example 10, which may be optionally configured according to one of the working examples 1 to 9, the proportion (e.g., volume proportion) of water vapor in the material stream is reduced by the liquid separation stage (e.g., condensation stage), e.g., by at least 10% of the proportion. Alternatively or additionally, the liquid separation stage is configured to reduce the proportion of water vapor in the material stream by at least 10% of the proportion.

According to a working example 11, which may be optionally configured according to one of working examples 1 to 10, the material stream fed to the solid separation stage has a proportion of water vapor of less than 100% of the saturation proportion relative to the dew point of the solid separation stage.

According to a working example 12, which may be optionally configured according to one of working examples 1 to 11, the material flow has one or more than one (e.g., solid) component (e.g., a toxic material) of a coating material by which the substrate is coated. Alternatively or additionally, the material stream contains abrasion produced during transport of the substrate and/or during operation of the coating device, e.g., when switching the mechanical vacuum components of the coating device.

According to an embodiment 13, which may be optionally configured according to one of embodiments 1 to 12, the liquid separation stage and the solid separation stage are integrated in a housing, providing a compact architecture.

According to a working example 14, which may be optionally configured according to one of working examples 1 to 13, the solid separation stage is coupled to the pump station by the liquid separation stage.

According to a working example 15, which may be optionally configured according to one of working examples 1 to 14, a closed liquid circuit is provided along which liquid delivered from the liquid reservoir (e.g., as gas or suspended matter) to the material flow is separated by the liquid separation stage and returned to the liquid reservoir in liquid form. The liquid circuit inhibits the escape of hazardous materials, e.g., toxic materials.

According to an embodiment 16, which may be optionally configured according to one of embodiments 1 to 15, the recirculation device provides a return line to the pump, by which the liquid separated from the material stream is fed to the pump.

According to a working example 17, which may be optionally configured according to one of working examples 1 to 16, the material flow has one or more components (e.g., suspended solids) that are considered toxic, which originate, for example, from the coating process.

According to a working example 18, which may be optionally configured according to one of working examples 1 to 17, the liquid reservoir is provided by a liquid used in processing the substrate.

According to a working example 19, which may be optionally configured according to one of working examples 1 to 18, the return device provides a drain by which the liquid separated from the material flow is fed to a liquid ring pump by which the material flow is conveyed (e.g., transferred).

According to a working example 20, which may be optionally configured according to one of working examples 1 to 19, the material flow is cooled by a cooling device of the liquid separation stage, which promotes the condensation of water vapor carried along with the material flow. The cooling device may have one or more cooling lines which are exposed to the material flow in the interior of the liquid separation stage.

According to an embodiment 21, which may be optionally configured according to one of embodiments 1 to 20, the baffles of the liquid separation stage are cooled by the cooling device, which promotes the condensation of water vapor carried along with the material flow. The cooling device is provided by a cooling channel through which a cooling fluid flows and which is thermally (e.g., conductively) coupled to the baffles.

According to a working example 22, which may be optionally configured according to one of working examples 1 to 21, when the material flow is exposed to the pump's liquid reservoir, it releases particles as a solid component into the liquid reservoir. As a result, the liquid in the liquid reservoir forms a suspension, which may impair the operation of the pump, for example, due to increased abrasion and/or wear. Alternatively or additionally, the formation of the suspension may make it difficult to circulate the liquid due to a blocked line, promote the accumulation of dirt on sensors, or promote the e closure of lubrication channels on bearings and shafts. To inhibit this, the liquid reservoir (e.g., of the pump) is coupled to a third separation stage, which is configured to separate the particles as a solid component of the suspension. The third separation stage has, for example, a circulation device (e.g., circulation pump) (e.g., separate from the pump) circulation device (e.g., circulation pump) which is configured to circulate the liquid reservoir, for example through a particle filter (e.g., suspended matter filter) of the third separation stage, so that it is flowed through by the suspension from the liquid reservoir. The third separation stage can, for example, increase the service life of the pump. The liquid reservoir is, for example, already circulated by operation within a liquid ring pump. However, this is not sufficient to drive the liquid through the third separation stage, which may be supported by a circulation pump, since the third separation stage (e.g., particle filter) generates a differential pressure.

According to a working example 23, which may be optionally configured according to one of the working examples 1 to 22, a vacuum application takes place in which the moisture content of the material flow may be very low (in addition to gas, water may also be conveyed (e.g., transferred) from a vacuum chamber, which limits the pressure in the vacuum chamber to approximately 21 mbar), and would be saturated with liquid (i.e., 100%) after passing through the liquid ring pump, but may also be less than 100%, which does not limit the application here as a liquid separation stage. However, the moisture content of the material flow itself could also be higher if the applications are broader than classic vacuum applications, i.e., in particular those that convey (e.g., transfer) significant amounts of moisture content from a vacuum chamber.

According to a working example 24, which may be optionally configured according to one of the working examples 1 to 23, no water vapor should condense in the solid separation stage in order to avoid straining its filters ( ). The condition at which moisture condenses is a function of the dew point. However, a separation device that is independent of the dew point (which, for example, removes all moisture from the material flow) is not necessarily required.

According to a working example 25, which may be optionally configured according to one of the working examples 1 to 24, the material flow fed to the liquid ring pump has a relative humidity of less than 10%, which is increased during passage through the liquid ring pump to a value above the moisture value of the dew point of the solid separation stage.

According to a working example 26, which may be optionally configured according to one of working examples 1 to 25, a sufficient amount of dry purge gas (or dry air) is used to dilute the material flow. The dew point may be increased by heating critical surfaces of the filters and/or the areas around the filters.

According to a working example 27, the first separation stage (e.g., the filter thereof) is prone to the fluid component (e.g., water). For example, the (e.g., air) transfer resistance of the first separation stage increases with the amount of the fluid component (e.g., water) received (e.g., accumulated, e.g., adsorbed) by the first separation stage. The transfer resistance may denote the resistance provided by the first separation stage to the material flow transferred by the first separation stage (e.g., from the second separation stage to an outlet of the first separation stage). As example, the fluid component (e.g., water) may accumulate in the pores of the first separation stage, thereby obstructing (e.g., preventing) air transfer through the pores. Other examples of the (e.g., permanent) impairment of the first separation stage (e.g., the filter thereof) by the fluid component are provided in the following:

Fiber agglomeration: When the fluid component (e.g., water) enters the first separation stage (e.g., the filter thereof), microscopic fibers of the first separation stage (e.g., the filter thereof) stick together. After drying, these clumps remain, creating larger pores that allow fine particles to pass through that would normally be captured.

Filtration efficiency reduction (e.g., permanent): The fluid component (e.g., moisture) neutralizes electrostatic forces within the first separation stage (e.g., the filter thereof). As a result, the first separation stage (e.g., the filter thereof) loses part of its ability to capture submicron particles, and this loss does not recover after drying.

Airflow resistance increasement: The fluid component (e.g., water) blocks the narrow air channels in the first separation stage (e.g., the filter thereof). This causes a high pressure drop, reducing airflow and thus reducing pump efficiency.

Structural deformation: Absorbed water causes the filter of the first separation stage (e.g., the filter paper or fiberglass mat thereof) to swell. This may deform pleats, collapse sections of the filter, or tear fibers under normal operating airflow.

Adhesive bonds failure: The adhesive (e.g., glues) of the filter of the first separation stage (e.g., that hold pleats, spacers, and seals in place) may soften or dissolve when wet. This leads to air bypassing the filter entirely.

Generation of leaks and bypass paths: As the filter of the first separation stage weakens, air may flow around damaged areas instead of through the media, allowing unfiltered air to pass downstream. This may combine with (e.g., overlay) the increased air transfer resistance of the filter, thereby reducing the material flow through the filter further, e.g., without noticeable increasement of the air transfer resistance of the first separation stage as such.

Certification loss: System safety and compliance are compromised by moisture. For example, in a regulated environment (e.g., cleanrooms or medical ventilation), a water-damaged HEPA filter no longer meets certification requirements and must be discarded.

According to a working example 28, the first separation stage (e.g., the filter thereof) is water absorptive.

According to a working example 29, the first separation stage (e.g., the filter, e.g., particulate air filter, thereof) includes a hydrophile (e.g., water-soluble and/or water absorptive) and/or polar component (e.g., adhesive, filter mat, etc.).

What is claimed is:

1. A separation system comprising:
a material flow source;
a first separation stage configured to separate a solid component;
a second separation stage configured to convey a material flow between the material flow source and the first separation stage, thereby separating a liquid component from the material flow; and
a recirculation device configured to supply the liquid component from the second separation stage to the material flow source.

2. The separation system according to claim 1, wherein the material flow source comprises or is coupled to a liquid reservoir to which the liquid component from the second separation stage is supplied and to which the material flow is exposed.

3. The separation system according to claim 2, further comprising a pump comprising the liquid reservoir, wherein the pump is configured to convey the material flow by the liquid reservoir and to supply it to the second separation stage.

4. The separation system according to claim 3, wherein the pump is a liquid ring pump.

5. The separation system according to claim 3, wherein the pump further comprises a third separation stage configured to reduce a ratio of solid to liquid components in the liquid reservoir.

6. The separation system according to claim 1, wherein the first separation stage comprises a particulate filter.

7. The separation system according to claim 1, wherein the first separation stage comprises a plurality of pores or fibers by which the solid component is separated.

8. The separation system according to claim 1, wherein the second separation stage comprises a liquid separator.

9. The separation system according to claim 1, wherein the second separation stage has a cavity and a wall element arranged therein, which provides a condensation surface, to which the material flow is exposed, for separating the liquid component.

10. The separation system according to claim 1, wherein the second separation stage has a bottom-side liquid drain into which the return device opens.

11. The separation system according to claim 1, further comprising a first fluid line coupled to the material flow source and opens into a cavity of the second separation stage which tapers towards the first fluid line.

12. The separation system according to claim 1, further comprising a cooling device configured to withdraw thermal energy from the second separation stage.

13. The separation system according to claim 1, wherein the first separation stage is prone to the fluid component.

14. The separation system according to claim 1, wherein the first separation stage comprises a porous filter.

15. The separation system according to claim 1, wherein the first separation stage comprises a hydrophile particulate air filter.

16. The separation system according to claim 15, wherein the particulate air filter comprises a hydrophile adhesive.

17. A vacuum arrangement comprising:
a vacuum chamber having a pump connection flange, and
the separation system according to claim 1, wherein the first separation stage is coupled to the pump connection flange by the second separation stage.

18. A separation system comprising:
a material flow source;
a first separation stage including a hydrophile particulate filter to separate a particulate component;
a second separation stage configured to transfer a material flow including moisture and the particulate component from the material flow source to the first separation stage, thereby separating the moisture from the material flow;
a recirculation device configured to supply the moisture from the second separation stage to the material flow source.

19. The separation system according to claim 18, wherein the particulate filter is a HEPA filter.
